(19) United States
(12) Patent Application Publication
(10) Pub. No.: US 2007/0205390 A1
(43) Pub. Date: Sep. 6, 2007

(54) Mn-Zn BASED FERRITE MATERIAL

(75) Inventors: Tomokazu Ishikura, Tokyo (JP); Shinichi Sakano, Tokyo (JP); Isao Nakahata, Tokyo (JP); Masahiko Watanabe, Tokyo (JP)

Correspondence Address: PEARNE & GORDON LLP, 1801 EAST 9TH STREET, SUITE 1200, CLEVELAND, OH, 44114-3108, US

(73) Assignee: TDK CORPORATION, Tokyo (JP)

(21) Appl. No.: 11/671,511

(22) Filed: Feb. 6, 2007

(30) Foreign Application Priority Data
Mar. 6, 2006 (JP) 2006-58795

(51) Int. Cl. H01F 1/00

(52) U.S. Cl. 252/62.62; 252/62.63; 252/62.59

(57) ABSTRACT

For the purpose of providing a Mn—Zn based ferrite material that is small in loss in high frequency bands of 1 MHz or more and in the vicinity of 100° C., the Mn—Zn based ferrite material includes: as main constituents, Fe₂O₃: 53 to 56 mol %, ZnO: 7 mol % or less (inclusive of 0 mol %), and the balance: MnO; and as additives, Co: 0.15 to 0.65% by weight in terms of CoO, Si: 0.01 to 0.045% by weight in terms of SiO₂ and Ca: 0.05 to 0.40% by weight in terms of CaCO₃; wherein the 6 value (the cation defect amount) defined in the present specification defined in the present specification.

### BACKGROUND OF THE INVENTION

1. Field of the Invention

The present invention relates to a Mn—Zn based ferrite material to be used in cores for, for example, power transformers and being small in core loss (Pcv, hereinafter simply referred to as loss as the case may be) in high frequency bands of 1 MHz or more, preferably 2 MHz or more.

2. Description of the Related Art

Recently, the downsizing of electric devices is remarkably developed. Accordingly, power sources mounted in various electric devices are also demanded to be further downsized. In general, when a transformer is driven with a sine wave, the magnetic flux density B is represented by B=(Eₚ/4.44NₚAf)×10⁷, where Eₚ represents the applied voltage [V], Nₚ represents the number of turns of the primary coil, A represents the sectional area of the core [cm²], and f represents the driving frequency [Hz]. As can be seen from the above formula, for the purpose of downsizing transformers, the use of high driving frequencies for the driving frequency is effective; consequently, in these years, demanded are such high performance cores that can be used with high frequencies of the order of a few MHz.

Currently, the Mn—Zn based ferrite material is among the core materials used in the highest proportions for devices such as power transformers. This material is certainly high in permeability in the low frequency bands of the order of 100 kHz and low in loss so as to satisfy the significant properties as a core material. However, this ferrite material is remarkably increased in loss for the driving frequencies as high as a few MHz, and hence is hardly used in practical applications in the recent circumstances that the driving frequencies are increasingly becoming higher. In relation to this problem, for example, Japanese Patent Laid-Open Nos. 6-310320 (Patent Document 1) and 7-130527 (Patent Document 2) disclose magnetic materials exhibiting low loss at 300 kHz to a few MHz, these magnetic materials being obtained by adding various oxides as additives to the Mn—Zn based ferrite materials. In this connection, under the claim that these materials are insufficient in the low-loss performance in high frequency bands, Japanese Patent Laid-Open No. 10-340807 (Patent Document 3) discloses a Mn—Co based ferrite material including Fe₂O_{3:} 52 to 55 mol %, CoO: 0.4 to 1 mol % and the balance substantially composed of MnO.

As for the loss, it is needless to say preferable that the minimum value of the loss is low, and an essential factor involved is the temperature property such that the loss varies little over a wide temperature range. In general, the smaller is the temperature variation of the loss, the more desirable is the temperature property of the loss; it is particularly demanded that small are the property variations in the temperature ranges applied in power transformers or the like, namely, in the temperature range from room temperature (25° C.) to around 100° C. Japanese Patent Laid-Open Nos. 6-310320 (Patent Document 1) and 7-130527 (Patent Document 2) disclose that the temperature variation of the loss exhibits a negative temperature coefficient at around room temperature, with a minimum of the absolute loss value at around 60 to 80° C.; however, these documents do not refer to the extent of the temperature variation of the loss in such a way problems associated with this extent remain to be solved. Additionally, Japanese Patent Laid-Open No. 8-191011 (Patent Document 4) discloses a Mn—Zn—Co based ferrite material, which has a low loss over a wide temperature range; however, this ferrite material is associated with the frequencies of the order of 100 kHz, for which Mn—Zn based ferrite materials are generally applied, and hence is not suitable for use in the frequency bands of 1 MHz or more to be the target bands of the present invention.
[Patent Document 1] Japanese Patent Laid-Open No. 6-310320
[Patent Document 2] Japanese Patent Laid-Open No. 7-130527
[Patent Document 3] Japanese Patent Laid-Open No. 10-340807
[Patent Document 4] Japanese Patent Laid-Open No. 8-191011

### SUMMARY OF THE INVENTION

The present invention has achieved on the basis of these technical problems, and takes as its object the provision of a Mn—Zn based ferrite material small in loss in the high frequency bands of 1 MHz or more and in the vicinity of 100° C.

It has hitherto been proposed that the loss is controlled by regulating the cation defect amount (δ defined in the following composition formula) of the Mn—Zn based ferrite material, in documents such as Japanese Patent Laid-Open Nos. 2002-255559 (Patent Document 5) and 2004-217452 (Patent Document 6). In either of Patent Documents 5 and 6, the targeted frequency bands are of the order of 100 kHz; Patent Documents 5 and 6 have proposed to set the 6 value at 0.0025 or less and at 0.0033 or less, respectively. In other words, it has been understood that the smaller cation defect amount δ is the more desirable when the targeted frequency bands are of the order of 100 kHz.

(Znₐ²⁺, Ni_{b}²⁺, Mn_{c}²⁺, Mn_{d}³⁺, Feₑ²⁺, Fe_{f}³⁺)₃O_{4+δ}

wherein a+b+c+d+e+f=3, and δ=a+b+c+(3/2)d+e+(3/2)f−4.
[Patent Document 5] Japanese Patent Laid-Open No. 2002-255559
[Patent Document 6] Japanese Patent Laid-Open No. 2004-217452

However, according to the study made by the present inventors, it has been found that it is advantageous for the cation defect amount δ to fall within a predetermined range for the purpose of reducing the loss in the high frequency bands of 1 MHz or more, in a contrast to the above description that the smaller cation defect amount δ is the more desirable. The present invention is based on this finding, and is a Mn—Zn based ferrite material, which includes: as main constituents, Fe₂O_{3:} 53 to 56 mol %, ZnO: 7 mol % or less (inclusive of 0 mol %), and the balance: MnO; and as additives, Co: 0.15 to 0.65% by weight in terms of CoO, Si: 0.01 to 0.045% by weight in terms of SiO₂ and Ca: 0.05 to 0.40% by weight in terms of CaCO₃; wherein the δ value (the cation defect amount) in the following ferrite composition formula (1) satisfies the relation 5×10^{-3≦δ≦}19×10⁻³.

(Znₐ²⁺, Ti_{b}⁴⁺, Mn_{c}²⁺, Mn_{d}³⁺, Feₑ²⁺, Fe_{f}³⁺, Co_{g}²⁺, Coₕ³⁺)₃O_{4+δ} (1)

wherein a+b+c+d+e+f+g+h=3, and δ=a+2b+c+(3/2)d+e+(3/2)f+g+(3/2)h−4 with the proviso that g:h=1:2.

In the Mn—Zn based ferrite material of the present invention, the δ value preferably satisfies the relation 10×10^{-3≦δ≦}17×10⁻³.

Additionally, in the Mn—Zn based ferrite material of the present invention, the ratio of the amount (% by weight) of Fe²⁺ (divalent iron) to the total amount of Fe (% by weight) denoted by Fe²⁺/Fe preferably satisfies the relation 0.04≦Fe²⁺/Fe≦0.05.

Further, the Mn—Zn based ferrite material of the present invention preferably includes at least one of Ti in an amount of 0.35 % by weight or less in terms of TiO₂ and Ta in an amount of 0.25% by weight or less in terms of Ta₂O₅.

According to the present invention, there is provided a Mn—Zn based ferrite material small in loss in the high frequency bands of 1 MHz or more and in the vicinity of 100° C.

### BRIEF DESCRIPTION OF THE DRAWINGS

FIG. 1 is a graph showing a relation between an oxygen partial pressure PO₂ in a sintering atmosphere and a cation defect amount δ and a relation between the same partial pressure and a ratio Fe²⁺/Fe;

FIG. 2 is a graph showing a relation between a temperature for measuring a core loss and the core loss Pcv for each of the cation defect amounts δ;

FIG. 3 is a graph showing a relation between the cation defect amount δ and the core loss Pcv;

FIG. 4 is a graph showing a relation between the ratio Fe²⁺/Fe and the core loss Pcv;

FIG. 5 is a graph showing a relation between the amount of Fe₂O₃ and the core loss Pcv;

FIG. 6 is a graph showing a relation between the amount of ZnO and the core loss Pcv;

FIG. 7 is a graph showing a relation between the amount of CoO and the core loss Pcv;

FIG. 8 is a graph showing a relation between the amount of SiO₂ and the core loss Pcv;

FIG. 9 is a graph showing a relation between the amount of CaCO₃ and the core loss Pcv;

FIG. 10 is a graph showing a relation between the amount of TiO₂ and the core loss Pcv;

FIG. 11 is a graph showing a relation between the amount of Ta₂O₅ and the core loss Pcv; and

FIG. 12 is a graph showing the relations between the temperature and the core loss Pcv in the presence and the absence of TiO₂.

### DETAILED DESCRIPTION OF THE PREFERRED EMBODIMENTS

As described above, the Mn—Zn based ferrite material according to the present invention satisfies the condition that the cation defect amount δ represented by the composition formula (1) falls in a range of 5×10⁻³≦δ≦19×10⁻³. In the high frequency bands of 1 MHz or more, when the cation defect amount δ is less than 5×10⁻³, the loss becomes large and the Mn—Zn based ferrite material is not suitable for practical application, in contrast to the conventional regulation of the cation defect amount δ to low values in the frequency bands of the order of 100 kHz. Also when the cation defect amount δ exceeds 19×10⁻³, the loss becomes large and the loss variation relative to the temperature variation becomes large. In the present invention, the cation defect amount δ falls preferably in a range of 10×10⁻³ ≦δ<17×10⁻³, and more preferably in a range of 11×10⁻³≦δ≦15×10⁻³.

The cation defect amount δ is an index for attaining low loss in the high frequency bands of 1 MHz or more. Another index proposed in the present invention is the ratio of the amount (% by weight) of Fe²⁺ (divalent iron) to the total amount of Fe (% by weight) in the Mn—Zn based ferrite material defined as Fe²⁺/Fe; by regulating the ratio Fe²⁺/Fe so as to satisfy the relation 0.04≦Fe²⁺/Fe≦0.05, the present invention can attain low loss in the high frequency bands of 1 MHz or more. The ratio Fe²⁺/Fe satisfies preferably the relation 0.042≦Fe²⁺/Fe≦0.048 and more preferably the relation 0.043≦Fe²⁺/Fe≦0.047.

With a fixed composition, the cation defect amount δ and the ratio Fe²⁺/Fe are inversely proportional to each other. Thus, with the increase of the cation defect amount δ, the ratio Fe²⁺/Fe decreases, and with the increase of the ratio Fe²⁺/Fe, the cation defect amount δ decreases. The cation defect amount δ and the ratio Fe²⁺/Fe vary depending on the oxygen partial pressure PO₂ at the time of sintering, in such a way that the increase of the oxygen partial pressure PO₂ can increase the cation defect amount δ.

Next, detailed description is made on the reasons for imposing constraints on the composition of the Mn—Zn based ferrite material according to the present invention.

Fe₂O_{3:} 53 to 56 mol %

Fe₂O₃ is an essential constituent to be one of the main constituents in the Mn—Zn based ferrite material of the present invention; when the amount of Fe₂O₃ is either too small or too large, the loss at 1 MHz or more is remarkably degraded. Accordingly, in the present invention, the amount of Fe₂O₃ is set at 53 to 56 mol %, preferably at 54 to 55 mol % and more preferably at 54.2 to 54.8 mol %.

ZnO: 7 mol % or less (inclusive of 0 mol %)

ZnO is also one of the main constituents in the Mn—Zn based ferrite material of the present invention. The amount of ZnO can control the frequency properties of the Mn—Zn based ferrite material. In other words, with decreasing amount of ZnO, the loss in the high frequency bands becomes smaller. When the amount of ZnO exceeds 7 mol %, the loss in the high frequency bands of 2 MHz or more is degraded, and hence the upper limit of the amount of ZnO is set at 7 mol %. Additionally, in ferrite materials absolutely without ZnO included therein, discontinuous grain growth (grain coarsening) is caused even by an extremely small deviation from the ideal sintering conditions. The discontinuous grain growth increases eddy-current loss in such high frequency bands of 1 MHz or more to cause the degradation of the loss. Accordingly, the amount of ZnO is preferably 0.1 to 5 mol % and more preferably 0.2 to 3 mol %.

The Mn—Zn based ferrite material according to the present invention additionally includes an oxide of Mn as one of the main constituents to be the balance in relation to Fe₂O₃ and ZnO. As the oxide of Mn, MnO and Mn₃O₄ can be used.

The Mn—Zn based ferrite material of the present invention includes the following additives in addition to the main constituents. The optimization of the amounts of these additives controls the loss reduction in the high frequency bands and the temperature properties of the loss.

Co: 0.15 to 0.65% by weight in terms of CoO

When the amount of Co is too small, the reduction effect of the loss in the high frequency bands cannot be attained to a sufficient extent, and hence the lower limit of the amount of Co is set at 0.15% by weight. Additionally, with the increase of the amount of Co, the loss at low temperatures is drastically degraded due to the increase of the crystal magnetic anisotropy. Accordingly, the amount of Co is set at 0.65% by weight or less in terms of CoO. The amount of Co is, in terms of CoO, preferably 0.2 to 0.55% by weight and more preferably 0.2 to 0.4% by weight.

Si: 0.01 to 0.045% by weight in terms of SiO₂

Si is segregated in the grain boundary and has an effect to increase the grain boundary resistance and to decrease the eddy-current loss, which effect provides an effect to reduce the loss in the high frequency bands. For the purpose of attaining this effect, Si is added in an amount of 0.01% by weight or more in terms of SiO₂. However, excessive addition of Si induces the discontinuous grain growth to result in remarkable degradation of the loss and also in degradation of the temperature properties of the loss. Accordingly, the amount of Si is set at 0.045% by weight or less in terms of SiO₂. The amount of Si is, in terms of SiO₂, preferably 0.015 to 0.028% by weight and more preferably 0.015 to 0.025% by weight.

Ca: 0.05 to 0.40% by weight in terms of CaCO₃

Ca is segregated in the grain boundary and has an effect to increase the grain boundary resistance and to decrease the eddy-current loss, which effect provides an effect to reduce the loss in the high frequency bands. For the purpose of attaining this effect, Ca is added in an amount of 0.05% by weight or more in terms of CaCO₃. However, excessive addition of Ca induces the discontinuous grain growth to result in remarkable degradation of the loss and also in degradation of the temperature properties of the loss. Accordingly, the amount of Ca is set at 0.4% by weight or less in terms of CaCO₃. The amount of Ca is, in terms of CaCO₃, preferably 0.05 to 0.30% by weight and more preferably 0.12 to 0.25% by weight.

Ti: 0.35% by weight or less in terms of TiO₂ (inclusive of 0% by weight)

The Ti added as an additive is partially solid-soluted within the ferrite grains to provide an effect to increase the resistance within the grains, and also partially present in the grain boundary to increase the grain boundary resistance. Thus, the eddy-current loss is reduced, and hence the core loss Pcv (2 MHz, 50 mT) in the high frequency bands is improved particularly in the temperature range of 100° C. or lower as shown in FIG. 12. However, excessive addition of Ti degrades the loss in the high frequency bands in the vicinity of 100° C. and also results in degradation of the temperature properties of the loss. Accordingly, the addition amount of Ti is set at 0.35% by weight or less in terms of TiO₂. The amount of Ti is, in terms of TiO₂, preferably 0.05 to 0.3% by weight and more preferably 0.08 to 0.25% by weight. It is to be noted that Ti is not an essential element in the present invention.

Ta: 0.25% by weight or less in terms of Ta₂O₅ (inclusive of 0% by weight)

Ta is segregated in the grain boundary similarly to Si, and has an effect to suppress the grain growth and increase the grain boundary resistance. This effect provides an effect to reduce the loss in the high frequency bands. For the purpose of attaining the effect to reduce the loss, Ta is added according to need. However, excessive addition of Ta reduces the resistance to result in degradation of the loss in the high frequency bands. Accordingly, the amount of Ta is set at 0.25% by weight or less in terms of Ta₂O₅. The amount of Ta is, in terms of Ta₂O₅, preferably 0.01 to 0.2% by weight and more preferably 0.02 to 0.15% by weight. It is to be noted that Ta is also not an essential element in the present invention.

Hereinafter, description is made on a preferable method for preparing the Mn—Zn based ferrite material of the present invention.

As the raw materials for the main constituents, powders of oxides or powders of compounds to be converted into oxides by heating are used. Specifically, for example, a Fe₂O₃powder, a Mn₃O₄ powder and a ZnO powder can be used. The mean particle size of each of these raw material powders may be appropriately selected to fall within a range from 0.1 to 3 μm.

The raw material powders for the main constituents are wet mixed, and then calcined. The calcination temperature may be set at 800 to 1000° C., and the calcination may be carried out in an atmosphere of between N₂ and air. The stable time of the calcination may be appropriately selected within a time range from 0.5 to 5 hours. After calcination, the calcined body is milled to a mean particle size of, for example, approximately 0.5 to 2 μm. It is to be noted that the raw materials for the main constituents are not limited to those described above, but powders of composite oxides including two or more metals may also be used as the raw materials for the main constituents. By oxidatively roasting an aqueous solution containing, for example, iron chloride and manganese chloride, a powder of a composite oxide containing Fe and Mn can be obtained. This powder may be mixed with the ZnO powder to prepare amixedrawmaterial of the main constituents. Such a case no more needs any calcination.

The Mn—Zn based ferrite material of the present invention includes the above described additives added in addition to the main constituents. The raw material powders for these additives are mixed with the mixed raw material powder of the main constituents obtained by milling after calcination. However, the raw material powders for these additives may also be mixed with the raw material powders for the main constituents so as to be thereafter calcined together with the main constituents.

The mixed powder composed of the main constituents and the additives may be granulated into granules for the purpose of smoothly carrying out a subsequent compacting step. The granulation can be carried out by using, for example, a spray dryer. To the mixed powder, an appropriate binder such as polyvinyl alcohol (PVA) is added in a small amount, and the mixture thus obtained is sprayed to be dried with a spray dryer. The particle size of the obtained granules is preferably set at approximately 80 to 200 μm.

The obtained granules are compacted into a desired shape by using a press equipped with a die having a predetermined shape, and the compacted body is subjected to a sintering step. In the sintering, the compacted body is retained in a temperature range from 1050 to 1350° C. for approximately 2 to 10 hours. By regulating the atmosphere of this sintering, in particular, the oxygen partial pressure PO₂ at a stable temperature, the cation defect amount δ or the ratio Fe²⁺/Fe can be varied. For the purpose of setting the cation defect amount δ to satisfy the relation 5×10⁻³≦δ≦19×10⁻³, the oxygen partial pressure PO₂ at the stable temperature can be set to be approximately 0.8 to 3%, although the appropriate oxygen partial pressure is dependent on the main constituent composition and the sintering temperature.

### EXAMPLE 1

As the raw materials for the main constituents, a Fe₂O₃ powder, a ZnO powder and a Mn₃O₄ powder were prepared, and as the raw materials for the additives, a CoO powder, a SiO₂ powder, a CaCO₃ powder, a TiO₂ powder and a Ta₂O₅ powder were prepared. These raw material powders were weighed out so as to give each of the mixture compositions shown in Table 1. Thereafter, toroidal Mn—Zn based ferrite sintered bodies (cores) were prepared under the following preparation conditions and the sintering conditions (the retention time: 6 hours) shown in Table 1.

Pot for mixing and milling: Stainless steel pot for ball mill was used.
Media for mixing and milling: Steel balls were used.
Mixing time: 16 hours
Calcination temperature and time: 850° C. and 3 hours
Milling time: 16 hours
Compacting: With compacted body density of 3 g/cm³
Sample dimension: T10 shape (a toroidal shape of 20 mm in outside diameter, 10 mm in inside diameter, and 5 mm in height)

### [Cation Defect Amountδ]

The cation defect amount δ of each of the sintered bodies obtained as described above was derived with the following method on the basis of the above described composition formula (1).

Specifically, the derivation of the δ value was carried out on the basis of the composition analysis and the quantitative determination of Fe²⁺ and Mn³⁺. In the composition analysis, each of the above sintered bodies was pulverized to be powdery, and then subjected to measurement with a fluorescent X-ray analyzer (Simultic 3530, manufactured by Rigaku Corp.) on the basis of the glass bead method. In the quantitative determination of Fe ²⁺ and Mn³⁺, each of the above sintered bodies was pulverized to be powdery, dissolved in an acid, and then subjected to a potentiometric titration with a K₂Cr₂O₇ solution. The quantitative determination of Zn²⁺, Ti⁴⁺, Co²⁺ and Co³⁺ was based on the assumption that the amounts of Zn and Ti determined by the composition analysis were exclusively associated with the divalent and tetravalent ion, respectively, and the ratio of divalent Co to trivalent Co was 1:2. The amounts of Fe³⁺ and Mn²⁺ were derived by subtracting the amounts of Fe²⁺ and Mn³⁺ obtained by the above potentiometric titration from the amounts of Fe and Mn determined by the composition analysis, respectively.

### [Fe²⁺/Fe]

The ratio Fe²⁺/Fe was derived from the composition analysis value of Fe and the quantitative determination value of Fe²⁺ obtained in the course of the measurement of the cation defect amount δ.

### [Core Loss (Pcv)]

Each of the toroidal sintered bodies obtained as described above was wound with a copper wire to form a 3-turn primary coil and a 3-turn secondary coil, and was subjected to measurement of the core loss (Pcv) by using a B—H analyzer (SY-8217, manufactured by Iwasaki Tsushinki Co., Ltd.), with the excitation magnetic flux density (Bm) set at 50 mT and the measurement frequency (f) set at 100 kHz to 2 MHz; the measurement was carried out in a temperature range from 25 to 140° C. with a thermostatic chamber.

Table 1 shows the obtained results for the cation defect amount δ and the ratio Fe²⁺/Fe, and FIG. 1 shows the relation between the oxygen partial pressure PO₂ in the sintering atmosphere and the cation defect amount δ and the relation between the same partial pressure and the ratio Fe²⁺/Fe. As can be verified from Table 1 and FIG. 1, the increase of the oxygen partial pressure PO₂ increases the cation defect amount δ and decreases the ratio Fe²⁺/Fe.

TABLE 1

| Main constituents | | | Additives | | | | | Sintering conditions | | | |
|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | |
| [mol %] | [mol %] | [mol %] | [wt %] | [wt %] | [wt %] | [wt %] | [wt %] | [° C. ] | [%] | [×10 ⁻³] | Fe²⁺/Fe |
| 54.35 | 45.53 | 0.12 | 0.24 | 0.020 | 0.22 | 0.12 | 0.07 | 1150 | 0.10 | 4.6 | 0.052 |
| 54.34 | 45.54 | 0.12 | 0.24 | 0.020 | 0.22 | 0.12 | 0.07 | 1150 | 0.50 | 9.0 | 0.049 |
| 54.36 | 45.53 | 0.12 | 0.24 | 0.020 | 0.22 | 0.12 | 0.07 | 1150 | 0.85 | 10.4 | 0.047 |
| 54.36 | 45.52 | 0.12 | 0.24 | 0.020 | 0.22 | 0.12 | 0.07 | 1150 | 1.15 | 12.4 | 0.045 |
| 54.35 | 45.53 | 0.12 | 0.24 | 0.020 | 0.22 | 0.12 | 0.07 | 1150 | 1.50 | 13.7 | 0.044 |
| 54.36 | 45.52 | 0.12 | 0.24 | 0.020 | 0.22 | 0.12 | 0.07 | 1150 | 2.00 | 16.3 | 0.042 |
| 54.35 | 45.53 | 0.12 | 0.24 | 0.020 | 0.22 | 0.12 | 0.07 | 1150 | 2.60 | 18.3 | 0.040 |

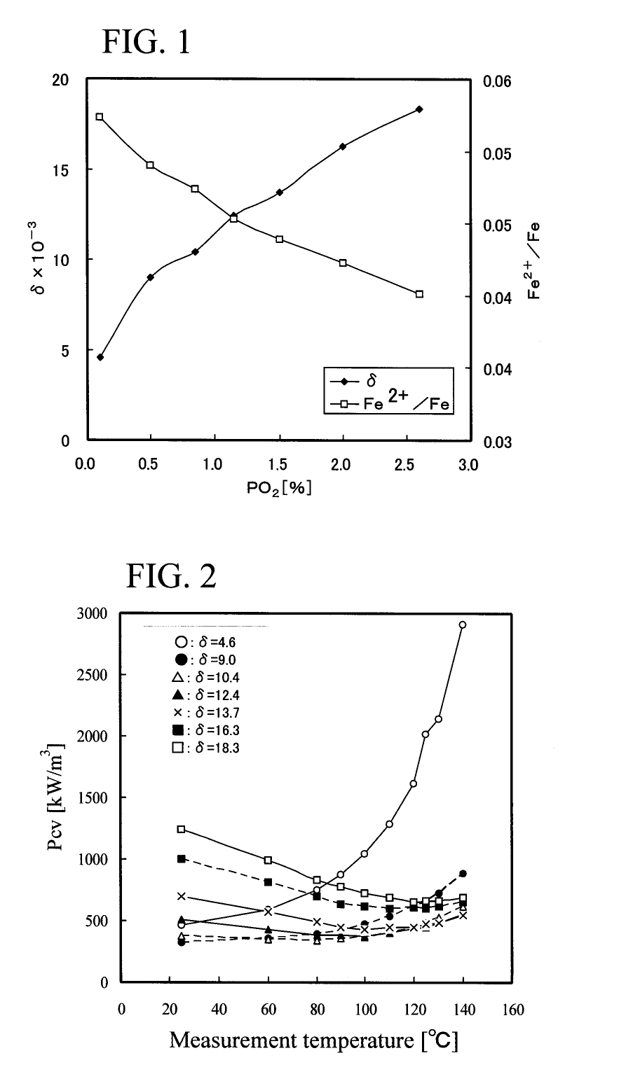

Next, Table 2 shows the core loss Pcv values obtained at the measurement frequency of 2 MHz in parallel with the cation defect amounts δ and the ratios Fe²⁺/Fe. FIG. 2 shows the relation between the temperature for measuring the core loss and the core loss Pcv for each of the cation defect amounts δ; the core loss Pcv and the variation of the core loss Pcv as a function of temperature vary depending on the cation defect amount δ. As can be seen from FIG. 2, by setting the cation defect amount δ so as to fall within the range specified in the present invention, low core loss can be attained and the variation of the core loss Pcv due to the temperature variation can be made small.

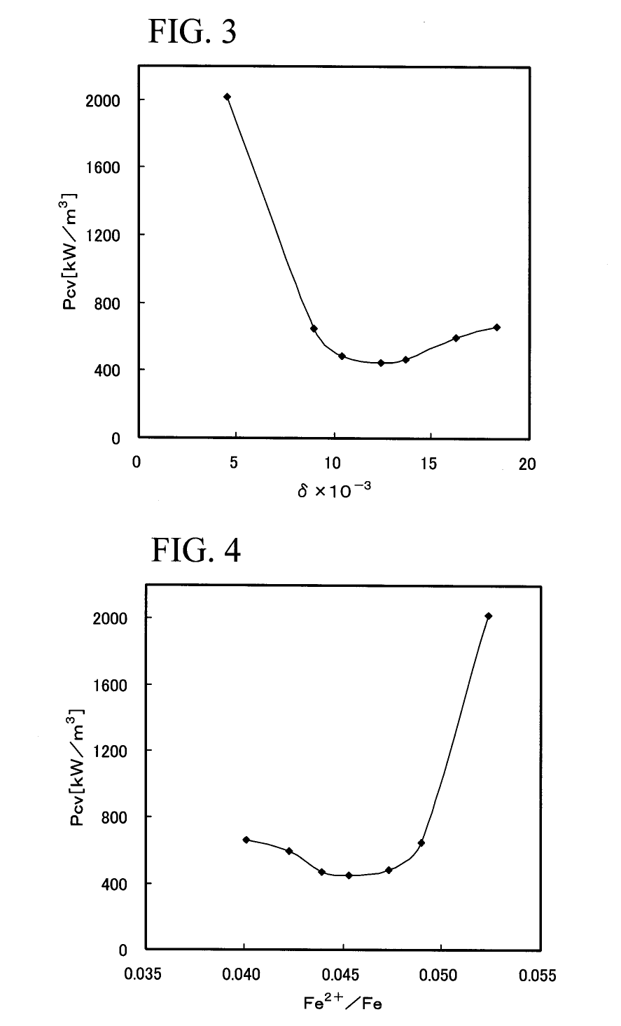

FIG. 3 shows the relation between the cation defect amount δ and the core loss Pcv, and FIG. 4 shows the relation between the ratio Fe²⁺/Fe and the core loss Pcv. As can be seen from these results, for the purpose of making the core loss Pcv low, the cation defect amount δ is required to satisfy the condition 5×10⁻³≦δ≦19×10⁻³. Also as can be seen from these results, the cation defect amount δ is preferably 10×10⁻³≦δ≦17×10⁻³ and more preferably 11×10⁻³≦δ≦15×10⁻³. On the other hand, the ratio Fe²⁺/Fe and the core loss Pcv are related to each other; for the purpose of making the core loss Pcv low, the ratio Fe²⁺/Fe is required to satisfy the condition 0.04≦Fe²⁺/Fe≦0.05. As can be seen from these results, the ratio Fe²⁺/Fe satisfies preferably the relation 0.042≦Fe²⁺/Fe≦0.048 and more preferably the relation 0.043≦Fe²⁺/Fe≦0.047.

TABLE 2

| | | Pcv 2 MHz-50 mT | | | | | | | | | |
|---|---|---|---|---|---|---|---|---|---|---|---|
| Amount δ | | Measurement temperatures (° C.) | | | | | | | | | |
| [×10⁻³] | Fe²⁺/Fe | 25° C. | 60° C. | 80° C. | 90° C. | 100° C. | 110° C. | 120° C. | 125° C. | 130° C. | 140° C. |
| 4.6 | 0.052 | 465 | 594 | 752 | 874 | 1049 | 1284 | 1613 | 2019 | 2146 | 2910 |
| 9.0 | 0.049 | 323 | 356 | 391 | 418 | 469 | 534 | 618 | 650 | 725 | 888 |
| 10.4 | 0.047 | 379 | 349 | 335 | 356 | 368 | 405 | 446 | 484 | 523 | 620 |
| 12.4 | 0.045 | 513 | 428 | 385 | 383 | 372 | 397 | 435 | 450 | 486 | 555 |
| 13.7 | 0.044 | 699 | 576 | 492 | 449 | 432 | 449 | 446 | 469 | 486 | 544 |
| 16.3 | 0.042 | 1004 | 812 | 693 | 638 | 614 | 595 | 612 | 599 | 614 | 654 |
| 18.3 | 0.040 | 1244 | 991 | 828 | 779 | 719 | 686 | 656 | 662 | 662 | 690 |

### EXAMPLE 2

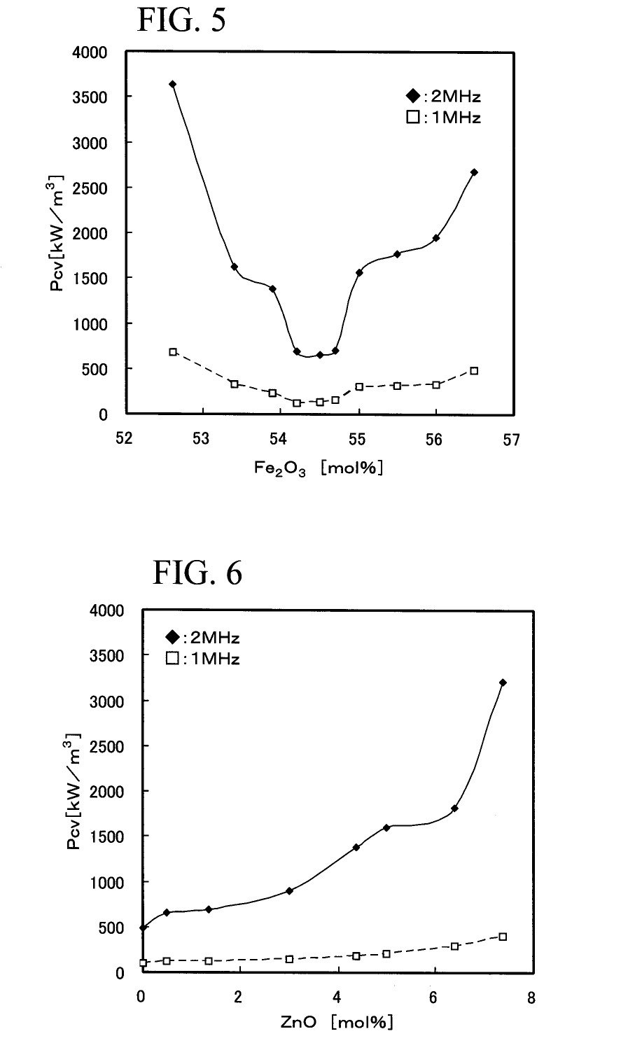

Sintered bodies were prepared in the same manner as in Example 1 except that the main constituent compositions, the additive compositions and the sintering conditions were set as shown in Table 3. The sintered bodies thus prepared were subjected to the same measurements as in Example 1. The results thus obtained are shown in Table 3. FIG. 5 shows the relation between the amount of Fe₂O₃ and the core loss Pcv. As can be seen from Table 3 and FIG. 5, when the amount of Fe₂O₃ is less than 53 mol % or exceeds 56 mol %, the core loss Pcv (125° C., 2 MHz, 50 mT) exceeds 2000 kW/m³. Thus, the amount of Fe₂O₃ is preferably 54 to 55 mol % and more preferably 54.2 to 54.8 mol %; in the latter case, the core loss Pcv can be made to be approximately 700 kW/m³ or less under the conditions of 125° C., 2 MHz and 50 mT.

TABLE 3

| Main constituents | | | Additives | | | | | Sintering conditions | | | | Pcv at 125° C. | |
|---|---|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | | 2 MHz, 50 mT | 1 MHz, 50 mT |
| [mol %] | [mol %] | [mol %] | [wt %] | [wt %] | [wt % ] | [wt %] | [wt %] | [° C.] | [%] | [×10⁻³] | Fe²⁺/Fe | [kW/m³] | [kW/m³] |
| 52.60 | 46.03 | 1.37 | 0.24 | 0.020 | 0.22 | 0.12 | 0.07 | 1150 | 0.85 | 12.5 | 0.033 | 3642 | 682 |
| 53.40 | 45.23 | 1.37 | 0.24 | 0.020 | 0.22 | 0.12 | 0.07 | 1150 | 0.85 | 12.8 | 0.041 | 1623 | 330 |
| 53.90 | 44.73 | 1.37 | 0.24 | 0.020 | 0.22 | 0.12 | 0.07 | 1150 | 0.85 | 13.0 | 0.042 | 1380 | 231 |
| 54.21 | 44.42 | 1.37 | 0.24 | 0.020 | 0.22 | 0.12 | 0.07 | 1150 | 0.85 | 13.5 | 0.044 | 692 | 117 |
| 54.50 | 44.13 | 1.37 | 0.24 | 0.020 | 0.22 | 0.12 | 0.07 | 1150 | 0.85 | 14.3 | 0.047 | 650 | 135 |
| 54.70 | 43.93 | 1.37 | 0.24 | 0.020 | 0.22 | 0.12 | 0.07 | 1150 | 0.85 | 14.5 | 0.049 | 703 | 159 |
| 55.00 | 43.63 | 1.37 | 0.24 | 0.020 | 0.22 | 0.12 | 0.07 | 1150 | 0.85 | 14.8 | 0.052 | 1565 | 301 |
| 55.50 | 43.13 | 1.37 | 0.24 | 0.020 | 0.22 | 0.12 | 0.07 | 1150 | 0.85 | 15.5 | 0.056 | 1775 | 320 |
| 56.00 | 42.63 | 1.37 | 0.24 | 0.020 | 0.22 | 0.12 | 0.07 | 1150 | 0.85 | 17.0 | 0.059 | 1950 | 330 |
| 56.50 | 42.13 | 1.37 | 0.24 | 0.020 | 0.22 | 0.12 | 0.07 | 1150 | 0.85 | 19.1 | 0.063 | 2680 | 480 |

### EXAMPLE 3

Sintered bodies were prepared in the same manner as in Example 1 except that the main constituent compositions, the additive compositions and the sintering conditions were set as shown in Table 4. The sintered bodies thus prepared were subjected to the same measurements as in Example 1. The results thus obtained are shown in Table 4. FIG. 6 shows the relation between the amount of ZnO and the core loss Pcv. As can be seen from Table 4 and FIG. 6, the increase of the amount of ZnO increases the core loss Pcv. For the purpose of attaining the core loss Pcv (125° C., 2 MHz, 50 mT) of 2000 kW/m³ or less, the amount of ZnO is required to be 7 mol % or less. In order to further reduce the core loss Pcv, the amount of ZnO is preferably 5 mol % or less and more preferably 3 mol % or less.

In this connection, when the amount of ZnO is 0 mol %, a microstructure can be attained by preparation under ideal preparation conditions, to yield satisfactory values of the magnetic properties and satisfactory values of the temperature dependence of the magnetic properties. However, even slight deviations from the ideal conditions such as the ideal sintering atmosphere and the ideal sintering temperature cause discontinuous grain growth. In other words, when the amount of ZnO is small, the sinterability is made unstable. Thus, the amount of ZnO is preferably 0.1 mol % or more and more preferably 0.2 mol % or more.

TABLE 4

| Main constituents | | | Additives | | | | | Sintering conditions | | | | Pcv at 125° C. | |
|---|---|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | | 2 MHz, 50 mT | 1 MHz, 50 mT |
| [mol %] | [mol %] | [mol %] | [wt %] | [wt %] | [wt % ] | [wt %] | [wt %] | [° C.] | [%] | [×10⁻³] | Fe²⁺/Fe | [kW/m³] | [kW/m³] |
| 54.37 | 45.64 | 0.00 | 0.24 | 0.020 | 0.22 | 0.12 | 0.07 | 1150 | 0.85 | 14.2 | 0.043 | 484 | 96 |
| 54.21 | 45.29 | 0.50 | 0.24 | 0.020 | 0.22 | 0.12 | 0.07 | 1150 | 0.85 | 13.9 | 0.044 | 651 | 125 |
| 54.21 | 44.42 | 1.37 | 0.24 | 0.020 | 0.22 | 0.12 | 0.07 | 1150 | 0.85 | 13.5 | 0.044 | 692 | 117 |
| 54.21 | 42.79 | 3.00 | 0.24 | 0.020 | 0.22 | 0.12 | 0.07 | 1150 | 0.85 | 12.9 | 0.044 | 902 | 143 |
| 54.21 | 41.42 | 4.37 | 0.24 | 0.020 | 0.22 | 0.12 | 0.07 | 1150 | 0.85 | 12.4 | 0.044 | 1380 | 187 |
| 54.21 | 40.79 | 5.00 | 0.24 | 0.020 | 0.22 | 0.12 | 0.07 | 1150 | 0.85 | 12.2 | 0.044 | 1600 | 206 |
| 54.21 | 39.39 | 6.40 | 0.24 | 0.020 | 0.22 | 0.12 | 0.07 | 1150 | 0.85 | 11.5 | 0.044 | 1820 | 290 |
| 54.21 | 38.42 | 7.37 | 0.24 | 0.020 | 0.22 | 0.12 | 0.07 | 1150 | 0.85 | 11.0 | 0.044 | 3214 | 395 |

### EXAMPLE 4

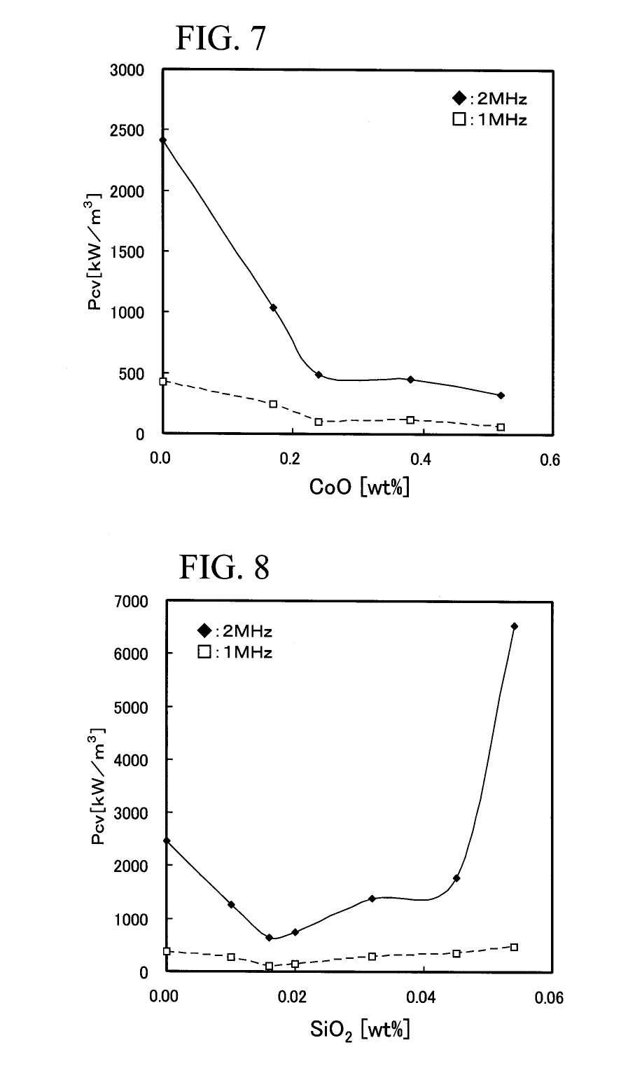

Sintered bodies were prepared in the same manner as in Example 1 except that the main constituent compositions, the additive compositions and the sintering conditions were set as shown in Table 5. The sintered bodies thus prepared were subjected to the same measurements as in Example 1. The results thus obtained are shown in Table 5. FIG. 7 shows the relation between the amount of CoO and the core loss Pcv. As can be seen from the results shown in Table 5 and FIG. 7, the addition of CoO can decrease the core loss Pcv; when the amount of CoO is 0.10% by weight or more, the core loss Pcv at 125° C. and 2 MHz can be made to be approximately 1000 kW/m³or less. However, the increase of the amount of CoO increases the crystal magnetic anisotropy to results in the increase of the core loss Pcv at the low temperatures of 100° C. or lower.

TABLE 5

| Main constituents | | | Additives | | | | | Sintering conditions | | | | Pcv at 125° C. | |
|---|---|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | | 2 MHz, 50 mT | 1 MHz, 50 mT |
| [mol %] | [mol %] | [mol %] | [wt %] | [wt %] | [wt %] | [wt %] | [wt %] | [° C.] | [%] | [×10⁻³] | Fe²⁺/Fe | [kW/m³] | [kW/m³] |
| 54.36 | 45.52 | 0.12 | 0.00 | 0.020 | 0.22 | 0.12 | 0.07 | 1150 | 0.85 | 8.8 | 0.172 | 2411 | 426 |
| 54.36 | 45.52 | 0.12 | 0.17 | 0.020 | 0.22 | 0.12 | 0.07 | 1150 | 0.85 | 9.7 | 0.048 | 1036 | 246 |
| 54.36 | 45.52 | 0.12 | 0.24 | 0.020 | 0.22 | 0.12 | 0.07 | 1150 | 0.85 | 10.4 | 0.047 | 484 | 96 |
| 54.36 | 45.52 | 0.12 | 0.38 | 0.020 | 0.22 | 0.12 | 0.07 | 1150 | 0.85 | 13.5 | 0.046 | 451 | 117 |
| 54.36 | 45.52 | 0.12 | 0.52 | 0.020 | 0.22 | 0.12 | 0.07 | 1150 | 0.85 | 15.3 | 0.300 | 324 | 64 |

### EXAMPLE 5

Sintered bodies were prepared in the same manner as in Example 1 except that the main constituent compositions, the additive compositions and the sintering conditions were set as shown in Table 6. The sintered bodies thus prepared were subjected to the same measurements as in Example 1. The results thus obtained are shown in Table 6. FIG. 8 shows the relation between the amount of SiO₂ and the core loss Pcv. As can be seen from the results shown in Table 6 and FIG. 8, the addition of SiO₂ can decrease the core loss Pcv. When the amount of SiO₂ is 0.010 to 0.045% by weight, the core loss at 125° C. and 2 MHz can be made to be 2000 kW/m³ or less.

TABLE 6

| Main constituents | | | Additives | | | | | Sintering conditions | | | | Pcv at 125° C. | |
|---|---|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | | 2 MHz, 50 mT | 1 MHz, 50 mT |
| [mol %] | [mol %] | [mol %] | [wt %] | [wt %] | [wt %] | [wt %] | [wt %] | [° C.] | [%] | [×10⁻³] | Fe²⁺/Fe | [kW/m³] | [kW/m³] |
| 54.16 | 44.52 | 1.32 | 0.24 | 0.000 | 0.16 | 0.12 | 0.07 | 1130 | 0.70 | 15.5 | 0.042 | 2457 | 365 |
| 54.16 | 44.52 | 1.32 | 0.24 | 0.010 | 0.16 | 0.12 | 0.07 | 1130 | 0.70 | 15.5 | 0.042 | 1256 | 265 |
| 54.16 | 44.52 | 1.32 | 0.24 | 0.016 | 0.16 | 0.12 | 0.07 | 1130 | 0.70 | 15.5 | 0.042 | 650 | 97 |
| 54.16 | 44.52 | 1.32 | 0.24 | 0.020 | 0.16 | 0.12 | 0.07 | 1130 | 0.70 | 15.5 | 0.042 | 740 | 154 |
| 54.16 | 44.52 | 1.32 | 0.24 | 0.032 | 0.16 | 0.12 | 0.07 | 1130 | 0.70 | 15.5 | 0.042 | 1389 | 285 |
| 54.16 | 44.52 | 1.32 | 0.24 | 0.045 | 0.16 | 0.12 | 0.07 | 1130 | 0.70 | 15.5 | 0.042 | 1775 | 360 |
| 54.16 | 44.52 | 1.32 | 0.24 | 0.054 | 0.16 | 0.12 | 0.07 | 1130 | 0.70 | 15.5 | 0.042 | 6549 | 485 |

### EXAMPLE 6

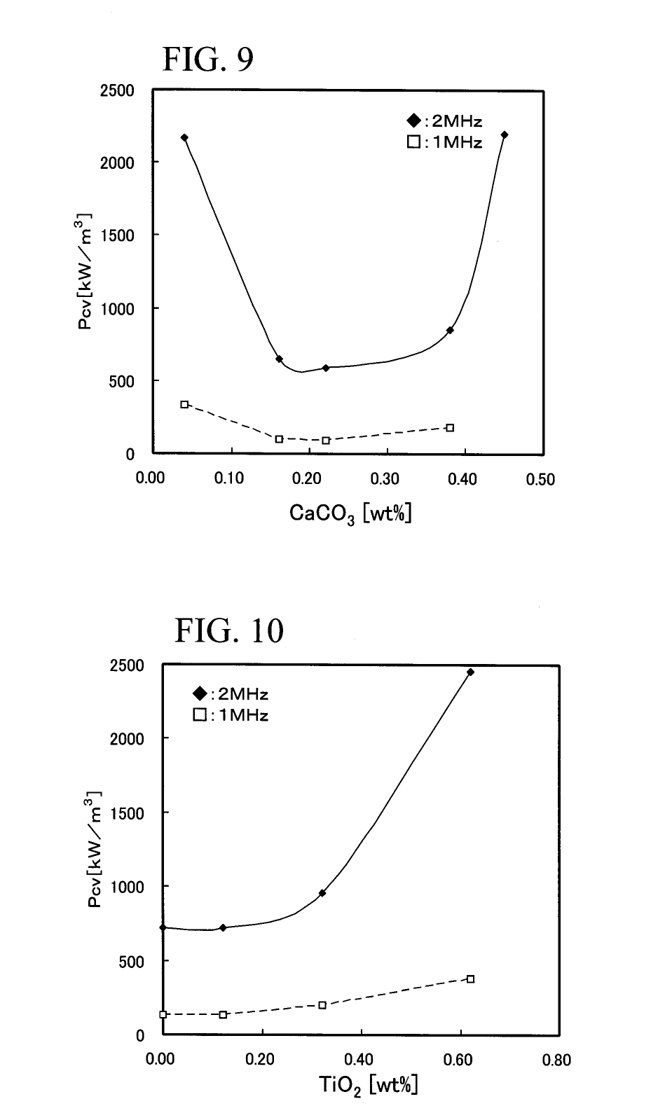

Sintered bodies were prepared in the same manner as in Example 1 except that the main constituent compositions, the additive compositions and the sintering conditions were set as shown in Table 7. The sintered bodies thus prepared were subjected to the same measurements as in Example 1. The results thus obtained are shown in Table 7. FIG. 9 shows the relation between the amount of CaCO₃ and the core loss Pcv. As can be seen from the results shown in Table 7 and FIG. 9, the addition of CaCO₃ can decrease the core loss Pcv; when the amount of CaCO₃ is 0.05 to 0.4% by weight, the core loss Pcv at 125° C.

TABLE 7

| Main constituents | | | Additives | | | | | Sintering conditions | | | | Pcv at 125° C. | |
|---|---|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | | 2 MHz, 50 mT | 1 MHz, 50 mT |
| [mol %] | [mol %] | [mol %] | [wt %] | [wt %] | [wt %] | [wt %] | [wt %] | [° C.] | [%] | [×10⁻³] | Fe²⁺/Fe | [kW/m³] | [kW/m³] |
| 54.16 | 44.52 | 1.32 | 0.24 | 0.016 | 0.04 | 0.12 | 0.07 | 1130 | 0.70 | 15.5 | 0.042 | 2170 | 330 |
| 54.16 | 44.52 | 1.32 | 0.24 | 0.016 | 0.16 | 0.12 | 0.07 | 1130 | 0.70 | 15.5 | 0.042 | 650 | 97 |
| 54.16 | 44.52 | 1.32 | 0.24 | 0.016 | 0.22 | 0.12 | 0.07 | 1130 | 0.70 | 15.5 | 0.042 | 589 | 91 |
| 54.16 | 44.52 | 1.32 | 0.24 | 0.016 | 0.38 | 0.12 | 0.07 | 1130 | 0.70 | 15.5 | 0.042 | 854 | 180 |
| 54.16 | 44.52 | 1.32 | 0.24 | 0.016 | 0.45 | 0.12 | 0.07 | 1130 | 0.70 | 15.5 | 0.042 | 2200 | 480 |

### EXAMPLE 7

Sintered bodies were prepared in the same manner as in Example 1 except that the main constituent compositions, the additive compositions and the sintering conditions were set as shown in Table 8. The sintered bodies thus prepared were subjected to the same measurements as in Example 1. The results thus obtained are shown in Table 8. FIG. 10 shows the relation between the amount of TiO₂ and the core loss Pcv. As can be seen from the results shown in Table 8 and FIG. 10, when TiO₂ is included in the amount range specified in the present invention, the core loss Pcv at 125° C. and 2 MHz can be made to be 1000 kW/m³ or less.

TABLE 8

| Main constituents | | | Additives | | | | | Sintering conditions | | | | Pcv at 125° C. | |
|---|---|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | | 2 MHz, 50 mT | 1 MHz, 50 mT |
| [mol %] | [mol %] | [mol %] | [wt %] | [wt %] | [wt %] | [wt %] | [wt %] | [° C.] | [%] | [×10⁻³] | Fe²⁺/Fe | [kW/m³] | [kW/m³] |
| 54.16 | 44.52 | 1.32 | 0.24 | 0.020 | 0.22 | 0.00 | 0.07 | 1150 | 0.85 | 13.6 | 0.041 | 720 | 131 |
| 54.16 | 44.52 | 1.32 | 0.24 | 0.020 | 0.22 | 0.12 | 0.07 | 1150 | 0.85 | 15.5 | 0.042 | 719 | 133 |
| 54.16 | 44.52 | 1.32 | 0.24 | 0.020 | 0.22 | 0.32 | 0.07 | 1150 | 0.85 | 17.3 | 0.044 | 956 | 198 |
| 54.16 | 44.52 | 1.32 | 0.24 | 0.020 | 0.22 | 0.62 | 0.07 | 1150 | 0.85 | 19.7 | 0.047 | 2456 | 378 |

### EXAMPLE 8

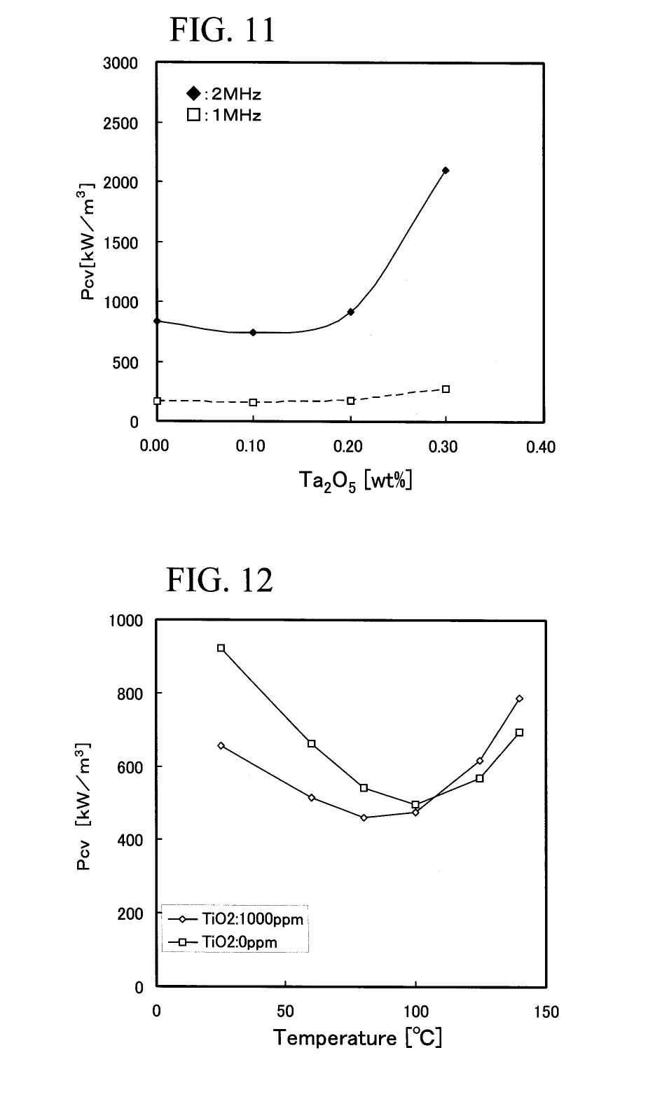

Sintered bodies were prepared in the same manner as in Example 1 except that the main constituent compositions, the additive compositions and the sintering conditions were set as shown in Table 9. The sintered bodies thus prepared were subjected to the same measurements as in Example 1. The results thus obtained are shown in Table 9. FIG. 11 shows the relation between the amount of Ta₂O₅ and the core loss Pcv. As can be seen from the results shown in Table 9 and FIG. 11, the addition of Ta₂O₅ can decrease the core loss Pcv. However, when the amount of Ta₂O₅ exceeds 0.25% by weight, the core loss Pcv is degraded.

TABLE 9

| Main constituents | | | Additives | | | | | Sintering conditions | | | | Pcv at 125° C. | |
|---|---|---|---|---|---|---|---|---|---|---|---|---|---|
| Fe₂O₃ | MnO | ZnO | CoO | SiO₂ | CaCO₃ | TiO₂ | Ta₂O₅ | Temperature | PO₂ | δ | | 2 MHz, 50 mT | 1 MHz, 50 mT |
| [mol %] | [mol %] | [mol %] | [wt %] | [wt %] | [wt %] | [wt %] | [wt %] | [° C.] | [%] | [×10⁻³] | Fe²⁺/Fe | [kW/m³] | [kW/m³] |
| 54.16 | 44.52 | 1.32 | 0.24 | 0.020 | 0.16 | 0.12 | 0.00 | 1130 | 0.70 | 15.5 | 0.042 | 836 | 167 |
| 54.16 | 44.52 | 1.32 | 0.24 | 0.020 | 0.16 | 0.12 | 0.10 | 1130 | 0.70 | 15.5 | 0.042 | 740 | 154 |
| 54.16 | 44.52 | 1.32 | 0.24 | 0.020 | 0.16 | 0.12 | 0.20 | 1130 | 0.70 | 15.5 | 0.042 | 920 | 170 |
| 54.16 | 44.52 | 1.32 | 0.24 | 0.020 | 0.16 | 0.12 | 0.30 | 1130 | 0.70 | 15.5 | 0.042 | 2100 | 278 |

What is claimed is:

1. A Mn—Zn based ferrite material comprising:
as main constituents,
Fe₂O₃: 53 to 56 mol %;
ZnO: 7 mol % or less (inclusive of 0 mol %); and
the balance: MnO; and
as additives,
Co: 0.15 to 0.65% by weight in terms of CoO;
Si: 0.01 to 0.045% by weight in terms of SiO₂; and
Ca: 0.05 to 0.40% by weight in terms of CaCO₃;
wherein:
the δ value (the cation defect amount) in the following ferrite composition formula (1) satisfies the relation 5×10⁻³≦δ≦19×10⁻³:
(Znₐ²⁺, Ti_{b}⁴⁺, Mn_{c}²⁺, Mn_{d}³⁺, Feₑ²⁺, Fe_{f}³⁺, Co_{g}²⁺, Coₕ³⁺)₃O_{4+δ} (1)
wherein a+b+c+d+e+f+g+h=3, and δ=a+2b+c+(3/2)d+e+(3/2)f+g+(3/2)h−4 with the proviso that g:h=1:2.

2. The Mn—Zn based ferrite material according to claim 1, wherein the δ value satisfies the relation 10×10⁻³≦δ≦17×10⁻³.

3. The Mn—Zn based ferrite material according to claim 1, wherein the δ value satisfies the relation 11×10⁻³≦δ≦15×10⁻³.

4. The Mn—Zn based ferrite material according to claim 1, wherein the ratio of the amount (% by weight) of Fe²⁺ (divalent iron) to the total amount (% by weight) of Fe denoted by Fe²⁺/Fe satisfies the relation 0.04≦Fe²⁺/Fe≦0.05.

5. The Mn—Zn based ferrite material according to claim 1, wherein the ratio of the amount (% by weight) of Fe²⁺ (divalent iron) to the total amount (% by weight) of Fe denoted by Fe²⁺/Fe satisfies the relation 0.042≦Fe²⁺/Fe≦0.048.

6. The Mn—Zn based ferrite material according to claim 1, wherein the amount of Fe₂O₃ is 54 to 55 mol %.

7. The Mn—Zn based ferrite material according to claim 1, wherein the amount of Fe₂O₃ is 54.2 to 54.8 mol %.

8. The Mn—Zn based ferrite material according to claim 1, wherein the amount of ZnO is 0.1 to 5 mol %.

9. The Mn—Zn based ferrite material according to claim 1, wherein the amount of Co is 0.2 to 0.55% by weight in terms of CoO.

10. The Mn—Zn based ferrite material according to claim 1, wherein the amount of Si is 0.015 to 0.028% by weight in terms of SiO₂.

11. The Mn—Zn based ferrite material according to claim 1, wherein the amount of Ca is 0.05 to 0.30% by weight in terms of CaCO₃.

12. The Mn—Zn based ferrite material according to claim 1, comprising at least one of Ti in an amount of 0.35% by weight or less in terms of TiO₂ and Ta in an amount of 0.25% by weight or less in terms of Ta₂O₅.

13. The Mn—Zn based ferrite material according to claim 1, comprising Ti in an amount of 0.05 to 0.3% by weight in terms of TiO₂.

14. The Mn—Zn based ferrite material according to claim 1, comprising Ta in an amount of 0.01 to 0.2% by weight in terms of Ta₂O₅.

15. The Mn—Zn based ferrite material according to claim 1, wherein:
the core loss thereof is 2000 [kW/m³] or less at 125° C., an excitation magnetic flux density of 50 mT and a measurement frequency of 2 MHz.

16. The Mn—Zn based ferrite material according to claim 1, wherein the amount of Co is 0.2 to 0.55% by weight in terms of CoO, the amount of Si is 0.015 to 0.028% by weight in terms of SiO₂, and the amount of Ca is 0.05 to 0.30% by weight in terms of CaCO₃.

17. The Mn—Zn based ferrite material according to claim 16, comprising at least one of Ti in an amount of 0.05 to 0.3% by weight in terms of TiO₂ and Ta in an amount of 0.01 to 0.2% by weight in terms of Ta₂O₅.

18. The Mn—Zn based ferrite material according to claim 16, wherein the δ value satisfies the relation 10×10^{-3≦δ≦}17×10⁻³.

19. The Mn—Zn based ferrite material according to claim 16, wherein the ratio of the amount (% by weight) of Fe²⁺ (divalent iron) to the total amount (% by weight) of Fe denoted by Fe²⁺/Fe satisfies the relation 0.04≦Fe²⁺/Fe≦0.05.

20. The Mn—Zn based ferrite material according to claim 16, wherein the amount of ZnO is 0.1 to 5 mol %.
